(19) United States
(12) Patent Application Publication
(10) Pub. No.: US 2023/0267810 A1
(43) Pub. Date: Aug. 24, 2023

(54) DISTRIBUTED LIVE BINGO SYSTEM AND METHODS

(71) Applicants: Luis G Villanueva, III, Burbank, IL (US); Ronald J Larson, Alsip, IL (US)

(72) Inventors: Luis G Villanueva, III, Burbank, IL (US); Ronald J Larson, Alsip, IL (US)

(21) Appl. No.: 18/111,843

(22) Filed: Feb. 20, 2023

Related U.S. Application Data
(60) Provisional application No. 63/313,091, filed on Feb. 23, 2022.

(51) Int. Cl. G07F 17/32

(52) U.S. Cl. CPC G07F 17/3286; G07F 17/3272; G07F 17/3244

(57) ABSTRACT

A distributed bingo system includes a networked computer system at a host station and player mobile devices at distributed gathering places. A live caller calls one or more bingo sessions from the host station, and the bingo sessions are broadcast to the player mobile devices. The player mobile devices are authenticated and placed into a live bingo session associated with a gathering place by inputting a code that is physically present at the gathering place and transmitting the code from the player mobile device to the networked computer system.

### CROSS-REFERENCE

This application claims the priority benefit of U.S. provisional patent application No. 63/313,091 filed on Feb. 23, 2022, entitled “DISTRIBUTED LIVE BINGO SYSTEM AND METHODS,” the entirety of which is hereby incorporated herein for all purposes.

### FIELD OF THE DISCLOSURE

The present disclosure relates to bingo games played using mobile devices. More particularly, it relates to a live bingo game played using mobile devices at distributed gathering locations.

### SUMMARY

According to an aspect of the disclosure, a distributed bingo system comprises a networked computer system located at a host station; player mobile devices; at least one gathering place; a site code, the site code being physically present at the gathering place; an external network; and bingo software executable by one or more of the networked computer system and the player mobile devices. The networked computer system is operatively connected to the player mobile devices via the external network. The bingo software comprises instructions for the networked computer system to place a first plurality of the player mobile devices into a live bingo gathering session associated with the gathering place when the site code is input into each of the first plurality of player mobile devices and transmitted by the player mobile device to the networked computer system. In addition, the bingo software comprising instructions for the networked computer system to transmit a broadcast of the live bingo gathering session to the player mobile device so placed into the live bingo gathering session.

### BRIEF DESCRIPTION OF THE DRAWINGS

Although the characteristic features of this disclosure will be particularly pointed out in the claims, the disclosed method and system, and how it may be made and used, may be better understood by referring to the following description taken in connection with the accompanying drawings forming a part hereof, wherein like reference numerals refer to like parts throughout the several views and in which:

FIG. 1 is a simplified block diagram of a distributed bingo system according to an embodiment.

FIG. 2 is a flow diagram of a distributed bingo method according to another embodiment.

FIG. 3 is a simplified block diagram of a distributed bingo system according to another embodiment.

A person of ordinary skill in the art will appreciate that elements of the figures above are illustrated for simplicity and clarity and are not necessarily drawn to scale. The dimensions of some elements in the figures may have been exaggerated relative to other elements to help to understand the present teachings. Furthermore, a particular order in which certain elements, parts, components, modules, steps, actions, events and/or processes are described or illustrated may not be required. A person of ordinary skill in the art will appreciate that, for simplicity and clarity of illustration, some commonly known and well-understood elements that are useful and/or necessary in a commercially feasible embodiment may not be depicted to provide a clear view of various embodiments per the present teachings.

### DETAILED DESCRIPTION

In the following description of various examples of embodiments of the disclosed system and method, reference is made to the accompanying drawings, which form a part hereof, and in which are shown by way of illustration various example devices, systems, and environments in which aspects of the disclosed system and method can be practiced. Other specific arrangements of parts, example devices, systems, and environments, can be used, and structural modifications and functional modifications can be made without departing from the scope of the disclosed system and method.

As illustrated in the accompanying drawings and described herein, the present disclosure provides system and method to call and play live bingo in a gathering place, such as a pub, bar, restaurant, or other food venue, and/or a collection of such gathering places, such as a plurality of chain restaurant locations. The system integrates a live host video feed with game play on player mobile devices at the gathering places. The live host video feed may be displayed on a fixed screen at each gathering place and/or on a display of each player mobile device.

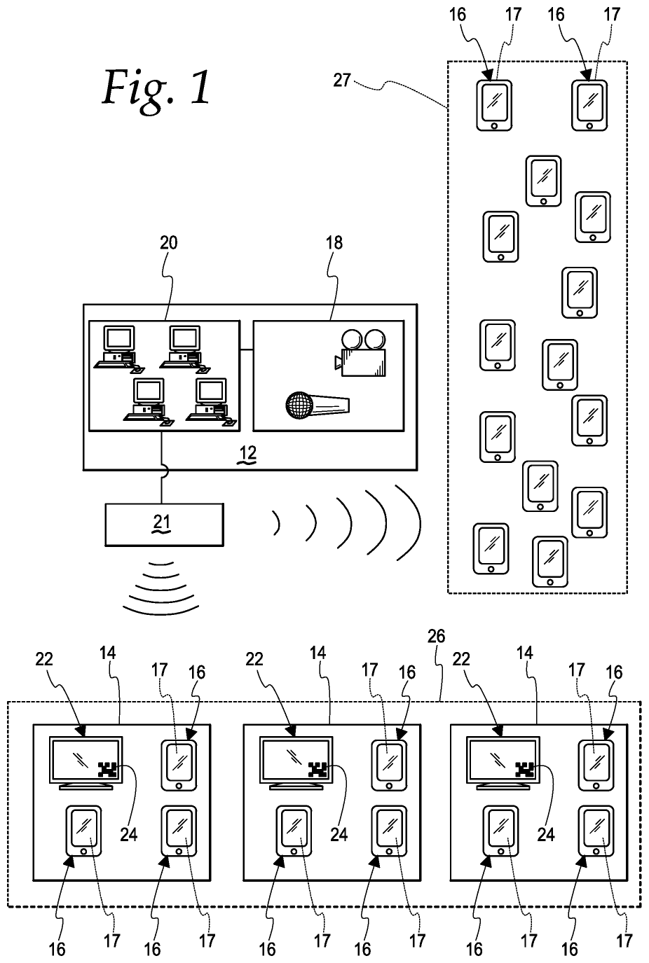

With reference to the simplified block diagram shown in FIG. 1, a distributed bingo system 10 comprises a host station 12 (in embodiments, a distributed bingo system comprises a plurality of host stations analogous to the host station 12), a plurality of distributed gathering places 14, and at each gathering place 14, a plurality of mobile devices 16. In embodiments, the host station 12 is located remote from all the gathering places 14. In other embodiments, the host station 12 is located at one of the gathering places 14 and remote from at least one other gathering place 14. Standard network broadcast equipment 18 located at the host station, such as a microphone operatively coupled to a networked computer system 20, interfaces with a live bingo caller, such as by the microphone registering the live bingo caller's voice orally calling drawn bingo numbers. The computer system 20 is operative to interface with an external network 21 using Internet Protocol (IP) to broadcast video and/or audio for a live bingo session to the plurality of player mobile devices 16. The player mobile devices 16 can for example comprise smartphones, smart watches, tablets, wearable computers, and/or other suitable devices which comprise a user input device, a display (a touch screen 17 typically serving as both an input device and a display), a microprocessor and memory, and a network adapter, so as to enable the device to perform the functions of a player mobile device 16 according to this disclosure. In addition, the computer system 20 is operative to interface with the external network 21 to broadcast the video and/or audio for the live bingo session to a presentation display 22 at each gathering place 14, which may for example be a television set, a computer monitor, or a video projector projecting broadcast video onto a screen, wall, or other viewing area at the gathering place 14.

In a method of conducting one or more live bingo sessions according to an embodiment, bingo software comprising one or more bingo software applications is executed by one or more electronic devices of the distributed bingo system 10. For example, the bingo software may comprise a player mobile app executed by each player mobile device 16 and a host or server application executed by the networked computer system 20. In embodiments, to play live bingo on the mobile app, each player is required to create a personal account and securely log in to the personal account on her player mobile device 16. More particularly, logging in to the personal account allows the player to access a personal digital wallet which may contain prizes. Executable code of the player mobile app may be installed on each player mobile device 16, on the networked computer system 20, or on another device (not shown) that is operatively connected to the player mobile devices 16 so as to cause the player mobile devices 16 to execute the code. Similarly, the networked computer system 20 may comprise one or more computing devices that perform operations of the method in response to encoded instructions received from other computing devices of the networked computer system 20. In embodiments, the networked computer system 20 comprises one or more computing devices that are physically remote from the host station 12. In embodiments, the networked computer system 20 may comprise computing devices physically located at one or more of the gathering places 14.

Each gathering place has an associated site code, which in the illustrated embodiment is a code 24 displayed on the presentation display 22 at each gathering place 14. A player will authenticate that s/he is present at an authorized gathering place 14 by inputting (for example, by scanning or typing) the code 24 into a mobile app user interface on her player mobile device 16. The code 24 can be string of numbers, a QR code, a keyword, or any other token capable of operating as an authentication token. In response to the code 24 being entered into the player mobile device 16, the player mobile device 16 transmits the code 24 to the networked computer system 20, and in response to receiving and authenticating the code 24, the networked computer system 20 places the player mobile device 16 into one or more bingo gathering sessions 26. More particularly, the player mobile device identifies the player's personal account to the networked computer system 20 when transmitting the code 24, so that the player herself is placed into the bingo gathering session 26, and prizes won by the player in the bingo gathering session 26 may be delivered to the personal digital wallet associated with the player's account, which can be accessed on the player mobile device 16 or another device, which may be another mobile device or, for example, a laptop or desktop personal computer, through which the player can log into her account, for example through an internet-connected desktop bingo application, or by accessing a website hosted by the computer system 20 through a web browser interface. A synchronized broadcast associated with a specific bingo gathering session 26 is transmitted by the computer system 20 to each player mobile device 16 that is placed into a local bingo gathering session 26.

In embodiments, the bingo software additionally allows players to play live bingo on the mobile app without entering the site code 24 or otherwise authenticating his or her presence at an authorized gathering place 14. For example, a player without access to a site code 24, such as a player who is at home or otherwise not present at any of the gathering places 14, can use the mobile app to send a request to the networked computer system 20 to join a live bingo general session 27. In response, the networked computer system 20 executes host application instructions to place such players into the live bingo general session 27 with other users who also have not checked in to one of the gathering places 14. One or more live bingo general sessions 27 can be called concurrently or simultaneously with, and separately from, one or more live bingo gathering sessions 26.

More particularly, a player logged into the player's personal account, via the mobile app running on the player's mobile device 16, can input a request to play live bingo immediately without a site code, for example, by tapping a button labeled “play bingo now,” “join open(/general/offsite) live bingo” or the like. In response, the networked computer system 20 can place the player's account into either a live bingo general session 27 already in progress, optionally allowing late-joining players, or alternatively all players, to “catch up” by displaying numbers that have already been called in that general session 27 on the corresponding mobile device screen(s) 17. In embodiments, the player's account can instead be queued for placement into a next available general session 27. The host application can direct the networked computer system 20 to initiate live bingo general sessions 27 at regular time intervals, independently of received player requests. In embodiments, alternatively or additionally, the host application can direct the networked computer system 20 to initiate general sessions 27 in response to receiving requests from at least a predetermined minimum number of players, such as at least one player, at least ten players, at least one hundred players, or some other minimum number of players not already placed into another general session 27.

In the case of creating general sessions 27 in response to player requests, each general session 27 can, for example, be initiated immediately upon reaching the minimum number of requesting players. In other embodiments, the general session 27 is initiated upon the earlier of the passage of a predefined wait time (for example, one minute) after the minimum number of requests is received and the number of requests reaching a predefined maximum number larger than the minimum number. Optionally, the mobile app may direct the player mobile devices 16 of a number of requesting players less than the minimum number to display virtual waiting room information on the players' screens 17, such as a current number of waiting players, and the minimum number of players required to start the bingo game. Where applicable, the mobile app can also display an indication that the bingo game will start automatically once the minimum number of players have joined, or in other embodiments, display an indication that the minimum number of players has been reached, the remaining wait time, and an indication that the bingo game will start automatically if the maximum number of players have joined before the end of the wait time. A live bingo general session 27 according to this disclosure is said to be “initiated” when the networked computer system 20 begins a simultaneous audio and/or video broadcast transmission of the general session 27 to the player mobile devices 16 that have been placed into the session 27, and/or when the networked computer system 20 transmits instructions to the mobile app on each player mobile device 16 in the session 27 to simultaneously display a bingo card for each player and to enable interactive player input via the player touchscreen 17, including but not limited to virtual “daubing” or marking and virtual bingo calling, as described elsewhere herein.

A single caller can call one or more bingo gathering sessions 26 and live bingo general sessions 27 from the host station 12. Calling a bingo gathering session 26 comprises the caller broadcasting drawn bingo numbers to the player mobile devices 16 and the gathering place presentation display 22 at each gathering place 14. The drawn bingo numbers can be drawn by any known manual, mechanical (such as using a bingo blower or rotary bingo cage to dispense a random bingo calling ball), or electronic means, which can be performed or initiated automatically (such as by the networked computer system running a host software program) or manually by the caller or another person. The caller can call a drawn bingo number by speaking the number live, such as into a microphone of the host station broadcast equipment 18, by initiating a live broadcast of a recording, or both, such as by using each method to call one or more of the drawn bingo numbers of the same bingo gathering session 26. The recording can be a previously recorded audio (and optionally video) clip of a person, such as a celebrity impersonator, (optionally drawing and) calling a drawn bingo number.

During a bingo gathering session 26, the caller can also insert commercials. For example, during a thirty-minute session six thirty-minute commercials may be inserted. In addition, during a two-hour session, a total of fifteen thirty-second commercials can be aired. The commercials are aired on all user apps. The application itself can also include one or more banner advertisements, which can vary as is known in the art. Coupons for advertised products can also be sent to a user's in-app wallet. Players may also be awarded a “wheel spin” as a bonus prize. Players winning the wheel spin may be selected at random from all players in the distributed bingo system 10 or from players at a particular gathering place 14, or players may win a wheel spin by attaining a certain bingo pattern on their bingo card, for example by filling the sixteen spots forming a “ring” around the border of the card. The wheel spin may be an animation displayed on the mobile app user interface on a player mobile device 16 (which may be spun by the user swiping the touch screen in a circumferential direction about the center of the displayed wheel) or a physical wheel present at a particular gathering place 14. A variety of prizes may be awarded based on the result of the wheel spin. Other special prizes or game opportunities may be awarded based on a player attaining a streak of a certain number of consecutive playing days, either in a bingo gathering session 26 or a live bingo general session 27, such as by randomly drawing a winner from players who have achieved the playing streak.

Location-specific prizes may be awarded to players who are part of a particular bingo gathering session 26 or who are present at a particular gathering place 14. For example, players that are present at a gathering place 14 which is a bar or food venue may be awarded a free menu item or a coupon redeemable at that bar or food venue, or an affiliated location. However, location-specific prizes need not be limited to prizes redeemable only at a venue, but may also include cash prizes. For example, players at a particular gathering place 14 may compete only among themselves to attain a particular cash prize for a particular bingo pattern, to enhance the competitive social environment at the gathering place 14. In embodiments, certain gathering places 14 may feature higher available cash prizes than other gathering places, such as on particular dates or days of the week when those gathering places 14 are “featured,” or at all times, such as for higher-priced bars or restaurants. In embodiments, to facilitate awarding location-specific prizes, multiple codes 24 are used to authenticate players at multiple gathering places 14 into the same bingo gathering session 26, so as to identify the gathering place 14 associated with each player mobile device 16 in the bingo gathering session 26. In some embodiments, the same code 24 may be displayed at multiple gathering places 14 that are of the same type, such as by belonging to the same bar or restaurant chain or affiliated chains. Prizes can be awarded as a certificate sent directly to the player's personal digital wallet. Location-specific prizes may be awarded to a randomly selected player or players at a gathering place 14, or based on a player at the gathering place 14 attaining a specific bingo pattern in a corresponding live bingo gathering session 26.

There can also be “premium” prizes, such as a progressive jackpot that starts at $1000 and is increased by $1000 per week until someone wins. The progressive jackpot can also be increased or decreased based on the number of participating locations. Participating locations may include all or a subset of all the gathering places 14 of the distributed bingo system 10. The progressive jackpot may be awarded, for example, to a user achieving a coverall, that is, filling all twenty-five spaces of a bingo card, within a predetermined count of numbers drawn, such as within thirty-five calls.

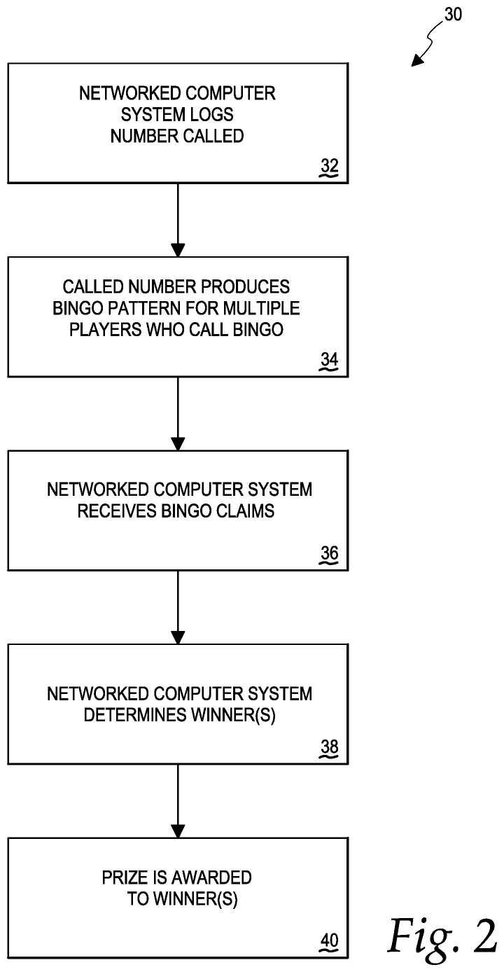

In some embodiments, the system 10 is adapted and configured to award an entire cash prize to no more than one player who has achieved a winning bingo pattern, while in other embodiments, the system 10 is adapted and configured to split the cash prize among multiple winners in certain circumstances. Illustrated in the flowchart shown in FIG. 2 is a method 30 of determining a winner or winners according to embodiments. Each number call is logged by the networked computer system 20 in a step 32. Following the number call, when multiple players attain the winning bingo pattern completed by the number called, and each of those players may “call bingo” or “declare bingo” in a step 34, for example by tapping a “bingo” button displayed by the mobile app on their respective mobile device 16, or by an attendant at the respective gathering place 14 electronically submitting the player's oral call of “bingo” to the networked computer system 20. The networked computer system 20 then receives each player's bingo claim in a step 36 and determines a winner or winners in a step 38, and a prize is awarded to the winner or winners in a step 40, such as by the networked computer system 20 transmitting the prize to the/each player's personal digital wallet, or in the case of a live bingo gathering session 26, by a site attendant physically delivering the prize to the/each player at the gathering place 14.

In a single-winner embodiment of the networked computer system 20 determines a single winner in the determination step 38, such as based on an earlier priority in time. In embodiments, priority in time can be based on when a bingo call is submitted or when it is received by the networked computer system 20. For example, when a bingo call or claim is input into a player mobile device 16, the mobile app may poll a clock time from each respective player mobile device 16 and transmit the clock time to the networked computer system 20 in the same data packet with the bingo call. In other single-winner embodiments, the single winner is simply the player whose bingo call is first received by the networked computer system 20, regardless of when the player submitted the call. In single-winner embodiments, players whose winning bingo calls are submitted or received later may be awarded no prize or a lower-level prize.

In shared prize embodiments, a prize may be divided in equal shares among players who attain and call a winning bingo pattern, or in unequal shares based on the order in which their bingo calls are submitted or received, the order being determined by a suitable method, such as one described above or another method. The winner determination step 38 is performed by the networked computer system 20 upon the occurrence of a predetermined event, for example, the expiration of a time period after the number that produced multiple winning bingo patterns is called, the calling of the next number, or the conclusion of the bingo session 26, 27.

In embodiments of the distributed bingo systems disclosed herein, using player mobile devices 16 and in other embodiments of distributed bingo systems according to this disclosure, the mobile app displays on the player mobile device 16 an image of a bingo card with an array of numbers (analogous to the number pattern 46 of the printed bingo cards 42 described herein) distributed in a five-by-five array, either in all twenty-five spots of the array, or in accordance with a convention, in the twenty-four spots excluding a center spot located in the third row and third column of the array, which is reserved for a “free” or “wild” space that is automatically considered filled for purposes of forming bingo patterns on the card. To fill in a selected spot on the card, the mobile app can require a player to tap the selected spot where it appears on the displayed card image. In embodiments, a virtual “daub” appears in a spot where the player has tapped, to indicate that the spot has been filled or daubed, which may or may not cover so as to obscure the number in the spot. An incorrect and/or inadvertently placed daub may be removed, for example by tapping it again, or by a double tap, “long” tap, or other specific type of tap or touch input.

In embodiments, the mobile app displays any spot on a player's card that has been tapped by the player as daubed, regardless of whether the spot contains a number that has in fact been called. In embodiments, the mobile app is programmed to input and validate or invalidate (accept or refuse) players' winning claims or “bingo calls.” In particular, when any a player invalidly attempts to “call bingo”—which may also be referred to as claiming, signaling, announcing, (virtually) yelling or shouting (a) bingo—through the mobile app interface, the player's bingo call is not transmitted to the networked computer system 20. In other embodiments, to encourage players to pay attention to the number calls, the mobile app may be programmed to disqualify a player from winning a prize when the player has exceeded a limit number of invalid bingo call attempts in a predefined time period, such as on a given calendar day or during any twenty-four-hour period. The player's disqualification may continue until the occurrence of a predefined event, such as the expiration of the subsequent such predefined time period or the completion of a given bingo gathering session. The limit number of invalid bingo call attempts permitted during that time period may, for example, be zero, one, two, three, or a greater whole number.

In other embodiments, the mobile app may be programmed with one or more of the following assistance features or modes, to encourage the participation of players with limited ability to track a bingo session, or who expect to be distracted during a given bingo session, by helping them avoid mistakes. For example, the mobile app may prevent a player from erroneously daubing a spot containing a number that has not actually been called. Alternatively or additionally, the mobile app may prevent the player from even attempting to “call bingo” through the mobile app interface when a winning pattern has not been formed, or when a winning pattern has been formed but is invalid because it includes a daub over a number that was not called. The mobile app may be programmed to display a message that there is no bingo when the player attempts to claim bingo without first forming the pattern, or without first validly forming the pattern. Alternatively, until a winning pattern is formed, or until a winning pattern is validly formed, the mobile app may display a “call bingo” or equivalent button that is “greyed out,” while deactivating any programmed response to the player tapping the area of the greyed-out button, or the “call bingo” button may not appear at all. In other embodiments, the mobile app may in certain circumstances alert a player that a number on the card was called but not daubed, or that a daubed number on the card was never called, for example by highlighting or flashing the spot in question, for example after a certain amount of time has elapsed after the call or the erroneous daub, for example intermittently, or alternatively continuously, until the player fixes the mistake, or until a prematurely daubed number is called so that the daub is no longer incorrect. In still other embodiments, the mobile app may play a player's bingo card automatically, by daubing spots in whenever the corresponding numbers are called. Optionally, the mobile app may even automatically call bingo when a winning pattern is formed.

In embodiments, players who use mobile app assistance such as described above are placed in separate bingo sessions 26, 26′, 27 from players who do not, to compete for prizes only against one another. In other embodiments, players using mobile app assistance may play in the same sessions, subject to limitations on their eligibility for certain prizes and/or stricter winning conditions, for example, having to form a winning pattern at least some number of calls before the first player to form that pattern without mobile app assistance.

In other embodiments, a certain number of “free passes” to use mobile app assistance (such as a certain number of auto-checks for any missed numbers called during a period of distraction) can be given to a player, without affecting the player's winning conditions or prize eligibility, whether randomly, as prizes, or as loyalty benefits based on play activity milestones.

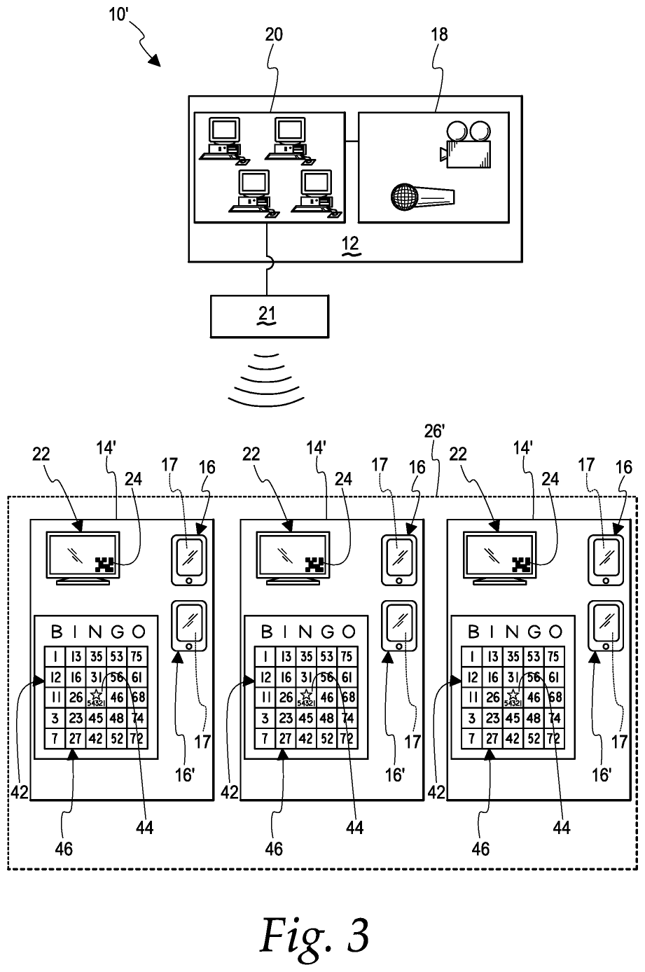

With reference to the simplified block diagram shown in FIG. 3, a distributed bingo system 10′ according to another embodiment is adapted and configured to place players using printed bingo cards 42 at one or more gathering places 14′ into one or more bingo gathering sessions 26′. In the illustrated embodiment, gathering places 14′ provide staff assistance to players using printed bingo cards 42 using a staff mobile device 16′, analogous to the player mobile device 16, which is logged into a staff portion of the mobile app. In other embodiments, staff may use a different type of internet-connected device, such as a laptop or desktop computer or other stationary terminal (not shown), equipped with suitable input devices (e.g., a scanner and keyboard or touch screen) and running a desktop version of the software (such as on a Windows® or macOS® operating system) to provide similar assistance as provided using the staff mobile device 16′ described here. In still other embodiments, players using printed bingo cards 42 are given access to one or more such devices at the gathering place 14′, such as one or more self-service kiosks or tethered handheld devices (not shown).

Printed on each printed bingo card 42 are a card identifier or card ID 44 and a number pattern 46. In an embodiment, the card ID 44 comprises what is known professionally as the “perm number” (from “permutation number”) or “free space number.” That is, according to an existing method of identifying print bingo cards, a manufacturer prints a series of unique bingo cards, each having a unique number pattern arbitrarily chosen from all possible patterns, each individual card of the series is identified by a perm number, which can for example be a four- or five-digit number, such as a number from one to nine thousand or from nine thousand one to eighteen thousand, or in the illustrated example, from fifty-four thousand one to sixty-three thousand, where a series includes nine thousand consecutively perm-numbered cards. The illustrated card ID 44 is only a five-digit perm number in standard Arabic numerals (shown for ease of illustration as the number “54321” on all cards 42, which accordingly have the same corresponding number pattern 46; however, it will be understood that, in typical embodiments, only unique cards 42, with unique card IDs 44 corresponding to unique number patterns 46, will be placed together into the same bingo gathering session 26′), but in other embodiments, the card ID may include a scannable image (e.g., a QR code, not shown) and/or a human readable image (e.g., characters in a standard font), and these may collectively represent the perm number and/or other identifying information. For example, the cards of a series may further be identified by a common serial number (not shown) and/or by color or other additional information that is provided on all cards of the series, and card ID 44 may include a representation of such additional information as well as the perm number. As illustrated, players using player mobile devices 16 to play bingo on the mobile app can be placed into the same bingo gathering session 26′ with players who play using printed bingo cards 42. Though not shown, players placed into any given bingo gathering session 26′ can alternately consist entirely of players using player mobile devices 16 or entirely of players using printed bingo cards 42.

In embodiments of the illustrated distributed bingo system 10′ and methods of using it, an electronic record of each printed bingo card 42 is stored on the computer system 20, the record comprising a card ID 44 associated with the printed bingo card 42 and a specific number pattern 46 that is printed on the card. The card ID 44 can then be used to authenticate that a player of a particular printed bingo card is present at a gathering place 14′ and to place the bingo card player into a corresponding bingo gathering session 26′ when the card ID 44 is input into a suitable card ID input device, such as by the player or by a staff assistant. The card ID input device is comprised in or operatively connected to the distributed bingo system 10′. More particularly, the illustrated card ID input device is a staff mobile device 16′ that is logged into a staff portion of the mobile app and operatively connected to the networked computer system 20.

In other embodiments of the illustrated distributed bingo system 10′ and methods of using it, an electronic record of the printed bingo card 42 does not have to be stored or subsequently looked up using the card ID 44, but rather can be directly determined from the card ID 44 by the distributed bingo system 10′ (or more particularly, its networked computer system 20). In such embodiments, at least a portion of the card ID 44 represents the entire number pattern 46 of the printed bingo card 42 or a reversible encryption of the entire number pattern 46. In such embodiments, the card ID input device and/or the networked computer system 20 are/is programmed to determine the number pattern 46 from the reversible encryption. However, it should be noted that the number of possible number patterns 46 on the printed bingo card 42 may be far greater than the number of possible perm numbers, or even the number of possible combinations of a perm number and a serial number, when the perm and serial numbers are in traditional formats. For example, there are approximately 5.52×10²⁶ possible patterns of numbers for a traditional American bingo card (which uses numbers from one to seventy-five, divided into five groups of fifteen that are assigned to appear in the spaces of five respective columns designated by the letters B-I-N-G-O), thus requiring a twenty-seven digit decimal number format to map a unique decimal number to each possible American bingo card number pattern, whereas it is conventionally known for an bingo card to have a perm number that is, for example, four to six digits. Therefore, in embodiments in which number patterns 46 are selected from all possible American bingo card patterns, it will be understood that the card ID 44 must contain more identifying information than solely a four- to six-digit perm number in order for the networked computer system 20 to read or calculate the number pattern 46 directly from the card ID 44, rather than using the card ID 44 to look up the number pattern 46 in a structured database (e.g., a table).

In embodiments in which the networked computer system 20 uses the card ID 44 of a bingo card 42 to looks up the corresponding number pattern 46 in a database such as a table (table not shown), the table itself may be identified by a card series identifier (card series identifier not shown) corresponding to a series of cards 42 whose records are stored in the table. In embodiments, the card series identifier may be represented in the card ID 44. In other embodiments, staff at a gathering place 14′ may manually input the card series identifier (and/or any such other information as required for the networked computer system 20 to determine a number pattern 46 of a bingo card 42 from the corresponding card ID 44). A card series identifier may include one or more suitable series identifying features as are commonly known in the industry, typically visible on any card 42 of the series. For example, information may be printed on the card 42, such as the identity of a manufacturer and/or a serial number, and/or the cards 42 may be printed on colored paper or backing material, or using colored ink, so as to readily distinguish a card 42 of that series from a card 42 of other series. In embodiments, an electronic table that maps the card IDs 44 to corresponding number patterns 46 may be physically stored within the networked computer system 20 or in another device that is communicatively linked to the networked computer system 20, for example on a website belonging to a third party manufacturer of the bingo cards 42.

When a player is given a printed bingo card 42, the corresponding card ID 44 is input into the card ID input device (such as by a staff member scanning or entering the card ID 44 into the staff mobile device 16′, or the player scanning or entering the card ID 44 into another type of internet-connected device), the card ID input device transmits the card ID 44 to the networked computer system 20, and the networked computer system 20 determines the number pattern 46 from the transmitted card ID 44, for example by extracting the number pattern 46 from the card ID 44 or by using the card ID 44 to look up the number pattern 46 in a stored record. The networked computer system 20 then places a guest player of the associated number pattern 46, which is either explicitly included in the card ID 44 or included with the card ID 44 in an electronic record of the bingo card 42 of the printed bingo card 42 into a bingo gathering session 26′ that includes players at the gathering place 14′ and uses the determined number pattern 46 to track the pattern formed by called numbers appearing on the guest player's card. This allows the networked computer system 20 either to automatically award prize to the player whenever a winning bingo pattern is formed, or when the player's bingo call is communicated to the networked computer system 20, to confirm whether the bingo call is valid or invalid. Optionally, guest player identifying information, such as a name, nickname, ID, or table number, is also submitted to the computer system 20 to be associated with the printed bingo card 42, so that the guest player of the printed bingo card 42 can be orally called on or otherwise contacted to be awarded location-specific prizes during the bingo gathering session 26′. Such location-specific prizes may be similar to those described above for the bingo system 10, for example, a free menu item to be redeemed during the player's visit, or a code or coupon redeemable at a subsequent visit.

In still other embodiments, the printed bingo card 42 is printed on site, on-demand by a networked device (not shown) at the gathering place 14′, which at the time of printing the bingo card 42, automatically enters the card into a session requested by the player, thus eliminating the need to scan the card.

Optionally, when a player joins a bingo gathering session 26′ using a printed bingo card 42, a guest account is created and stored on the networked computer system 20 for the player. The player may later log into the guest account to play on the mobile app, and/or to access messages or prizes through the mobile app or any web browser. For example, in embodiments, the guest player must later log into or “activate” the guest account to access an incentive, such as a prize won during the bingo gathering session 26′ or a welcome gift, such as a coupon for use at the gathering place 14′ at a later date. Optionally, the guest account is temporary; that is, must be claimed by the guest player logging into the temporary guest account within a limited time period to activate the temporary guest account, to create from the temporary guest account a normal (non-temporary) personal account. On the expiration of the limited time period without the guest player logging in, the networked computer system 20 will automatically delete the temporary guest account. Optionally, the guest player may use either the mobile app or a web browser to log into the guest account.

In embodiments in which guest accounts are created for printed card players, the staff may log into the player's newly created guest account, to join the session 26′ with an electronic bingo card that represents the card 42 (having the same number pattern 46), to follow along with the player's play on the printed card in the same manner as described above for a player on a player mobile device 16. Preferably, the staff instead uses a staff portion of the mobile app with special staff permissions and/or functions, such as the ability to display multiple guest players' equivalent electronic cards at once, or to toggle between players' respective cards, while logged into just one staff account. The staff portion of the mobile app may also provide mobile app assistance features such as described previously, and more particularly may provide the previously described automating daubing of called numbers on the electronic card image, to allow the staff to verify the validity of a bingo call by a player of a printed bingo card 42. In embodiments of the disclosed systems in which players on the mobile app are required to daub their electronic cards manually, staff may similarly have the ability to view an auto-daubed duplicate of mobile app players in the session, to facilitate human validation of a player's called bingo by the staff and/or to facilitate the staff using the image of the auto-played card to explain or point out to a player why their called bingo is invalid.

The preceding description of the disclosure has been presented for purposes of illustration and description and is not intended to be exhaustive or to limit the disclosure to the precise form disclosed. The description was selected to best explain the principles of the present teachings and the practical application of these principles to enable others skilled in the art to best utilize the disclosure in various embodiments and various modifications as are suited to the particular use contemplated. It should be recognized that the words “a” or “an” are intended to include both the singular and the plural. Conversely, any reference to plural elements shall, where appropriate, include the singular.

It is intended that the scope of the disclosure not be limited by the specification but be defined by the claim(s) set forth below. In addition, although narrow claims may be presented below, it should be recognized that the scope of this disclosure is much broader than presented by the claim(s). It is intended that broader claims will be submitted in one or more applications that claim the benefit of priority from this application. Insofar as the description above and the accompanying drawings disclose additional subject matter that is not within the scope of the claim or claims below, the additional disclosures are not dedicated to the public and the right to file one or more applications to claim such additional disclosures is reserved.

What is claimed is:

1. A distributed bingo system comprising:
a networked computer system located at a host station;
player mobile devices;
at least one gathering place;
a site code, the site code being physically present at the gathering place;
an external network; and
bingo software executable by one or more of the networked computer system and the player mobile devices;
the networked computer system being operatively connected to the player mobile devices via the external network;
the bingo software comprising instructions for the networked computer system to place a first plurality of the player mobile devices into a live bingo gathering session associated with the gathering place when the site code is input into each of the first plurality of player mobile devices and transmitted by the player mobile device to the networked computer system;
the bingo software comprising instructions for the networked computer system to transmit a broadcast of the live bingo gathering session to the player mobile device so placed into the live bingo gathering session.

2. The distributed bingo system of claim 1, further comprising a presentation display, the presentation display being physically present at the gathering place, the bingo software further comprising instructions for the networked computer system to transmit a broadcast of the live bingo gathering session to the presentation display.

3. The distributed bingo system of claim 2 wherein the presentation display is a display selected from the group consisting of a television set, a computer monitor, and a video projector.

4. The distributed bingo system of claim 1, further comprising printed bingo cards located at the gathering place and a card ID printed on each printed bingo card, the networked computer system being programmed to place one of the printed bingo cards into the live bingo gathering session when the card ID is transmitted to the networked computer system.

5. The distributed bingo system of claim 1, further comprising broadcast equipment operatively coupled to the networked computer system at the host station.

6. The distributed bingo system of claim 1 wherein the at least one gathering place comprises a plurality of gathering places, further comprising the host station being located remote from each of the gathering places.

7. The distributed bingo system of claim 1 wherein the at least one gathering place comprises a plurality of gathering places, further comprising the host station being located at one of the gathering places.

8. The distributed bingo system of claim 1 wherein the software comprises a player mobile app executable by each player mobile device and a host application executable by the networked computer system.

9. The distributed bingo system of claim 6 wherein the software comprises instructions to require each player to create and log in to a personal account on the player mobile device to enable the player to play live bingo on the mobile app.

10. The distributed bingo system of claim 7 wherein logging in to the personal account allows the player to access a personal digital wallet containing prizes.

11. The distributed bingo system of claim 1, further comprising the bingo software including instructions for the networked computer system, in response to receiving requests for admission into a live bingo general session from a second plurality of the player mobile devices, to place each of the second plurality of the player mobile devices into the live bingo general session without requiring the second plurality of the player mobile devices to transmit the site code to the networked computer system.

12. A method of using a distributed bingo system, the distributed bingo system comprising a networked computer system located at a host station, player mobile devices, at least one gathering place, a site code, the site code being physically present at the gathering place, and an external network, the networked computer system being connected to the player mobile devices via the external network, the method comprising:
inputting the site code into a first plurality of the player mobile devices;
the first plurality of the player mobile devices transmitting the input site code to the networked computer system;
the networked computer system, in response to receiving the transmitted site code from each of the first plurality of player mobile devices, placing the player mobile device into a live bingo gathering session associated with the gathering place; and
the networked computer system transmitting a broadcast of the live bingo gathering session to the first plurality of mobile devices.

13. The method of claim 10 wherein the distributed bingo system further comprises broadcast equipment operatively coupled to the network computer system at the host station, the method further comprising the broadcast equipment interfacing with a live bingo caller to broadcast video and/or audio for the live bingo gathering session to the first plurality of player mobile devices.

14. The method of claim 11 wherein the broadcast equipment comprises a microphone, and wherein the broadcast equipment interfacing with the live bingo caller comprises the microphone registering the live bingo caller's voice.
